(19) United States
(12) Patent Application Publication
(10) Pub. No.: US 2011/0240807 A1
(43) Pub. Date: Oct. 6, 2011

(54) Musical Instrument Stand

(76) Inventor: Caryn Anne Moberly, Oxon (GB)

(21) Appl. No.: 13/133,222

(22) PCT Filed: Dec. 8, 2009
(86) PCT No.: PCT/GB09/02835

§ 371 Date: Jun. 7, 2011

(30) Foreign Application Priority Data
Dec. 9, 2008 (GB) 0822473.5
Jun. 2, 2009 (GB) 0909508.4
Jul. 9, 2009 (GB) 0912004.9
Nov. 17, 2009 (GB) 0920118.7

(51) Int. Cl. G10G 5/00; A47F 7/00

(52) U.S. Cl. 248/176.3; 211/85.6

(57) ABSTRACT

A musical instrument stand which offers some protection to the instrument by absorbing mild pressure and knocks through being made of a spring material and configured to allow the components of the stand to bend and rotate in different directions, comprises a base for resting on a floor surface, a back portion extending upwardly from the base, a cradle portion for supporting the weight of the instrument in a vertical direction, and for restraining movement of the instrument in horizontal directions, and arms secured to the back portion above the cradle portion to hold the stringed instrument against lateral movement, and the base extending substantial distances to the rear and sides of the cradle portion for stability.

### FIELD OF THE INVENTION

The present invention relates to a musical instrument stand, particularly for stringed instruments such as cellos, guitars and violins that have a body portion and a neck portion along which the strings extend.

### BACKGROUND ART

Existing stands are usually designed to keep the instrument out and accessible for use, but do not focus on keeping the instrument safe in the home. Stands are usually made for musicians to take to gigs or recitals and are therefore robust and collapsible. An example of a guitar stand is shown in http://www.herculesstands.com/guitars/GS405B.html, the Hercules Stand GS405B. This has a tripod base, a post extending from the base, which is tiltable to absorb shocks, and which has a clasp at its free end to locate the neck of the instrument. Such stand is made of strong rigid material so that it is not damaged when the stand is handled roughly.

Various designs for stands for stringed musical instruments have been proposed. U.S. Pat. No. 4,582,282 discloses a guitar stand comprising rod-like front legs and a rod-like rear leg which form a supporting tripod. The body of the guitar is gripped between upturned front and rear ends of the front legs. This stand is not designed to absorb shock forces exerted on the guitar.

US-A-2005/0268771 discloses a guitar stand having a base member disposed on a supporting floor. An upstanding back member with the profile of a guitar has a supporting shock absorbing spring, and a collar at the top of the stand for gripping the guitar neck. Thus certain measures are provided to reduce the effects of impacts on the guitar when mounted on the stand. Of a somewhat similar design, a guitar stand has been proposed made of wood, http://www.sternerguitars.com/spring-stand.html,

U.S. Pat. No. 6,693,234 discloses a stand for a guitar which provides support for the guitar during a performance. It comprises a flexible rod, having its lower end placed on the stage floor, and terminating in a clip at its upper end which engages an edge of the guitar body.

U.S. Pat. No. 1,369,742 discloses a stand for a banjo, which comprises a base member for holding the body of the banjo, being formed of wire which is bent to form supporting legs and to form a region for supporting the banjo body. An upstanding arm, which is pivotally or resiliently mounted to the base member, is arranged to grip part of the banjo body.

Nevertheless, a need remains for a stand for a stringed musical instrument, which can absorb shock loadings and other impulse forces arising from accidental knocks, and rough usage, both in the home and in performance, and which is of an inexpensive but reliable construction. Children are more likely to play an instrument which is out and accessible rather than put away in its case (parents often prefer the instrument to be put away to keep it safe).

### SUMMARY OF THE INVENTION

It is an object of the invention to provide an instrument stand which offers some protection to the musical instrument by absorbing mild pressure and gentle knocks, and also allows the instrument to be handled more clumsily when being placed on the stand.

The concept of the invention is a musical instrument stand, which is composed of elongate members that are strong, but have flexibility and resilience in directions transverse of their length, and which may be bent or deformed into a desired configuration. Such elongate members may be formed for example of steel or other metal, or a suitable plastic material, or a wood or natural fibres or a composite combining the properties of different material groups including ceramics and glass, and may be in the form of a rod, tube, strip, or have any other cross-section. Such an elongate member will be referred to in this specification as an elongate member of the type defined herein.

In a first aspect, the invention provides a stand for a stringed musical instrument having a body portion and a neck portion along which the strings extend, the stand comprising a plurality of elongate members of the type defined herein, said elongate members being configured to provide a base for resting on a floor surface, a back portion extending upwardly from the base, a cradle portion for supporting the weight of the instrument in a vertical direction, and for restraining movement of the instrument in horizontal directions, and the stand including holding means secured to the back portion to hold the stringed instrument against lateral movement, and the base extending a substantial distance at least to the rear of the cradle portion for stability, the arrangement being such that the cradle portion and back portion are resiliently movable in use to absorb forces that may be exerted on the instrument.

In accordance with the invention, the stand is made of a flexible material which allows both the cradle portion and the back portion to move in any direction. The stand in accordance with the invention may absorb impulses and mild shocks that occur in any direction during use that is in vertical and horizontal directions, and also rotational torsional forces. One particular impulse force of concern is a diagonal force, having backwards and sideways components, which commonly occurs. Said cradle portion is operative to restrain dislodgement of the instrument in this situation. Further, rotational movement about the neck axis of the instrument may occur, in a generally horizontal plane. Again said cradle portion is operative to restrain dislodgement of the instrument in this situation

The stand in accordance with the invention has a wide base so that the instrument can lean over quite a lot before the combined centre of gravity of the stand and the instrument goes outside the footprint of the stand i.e. it is designed to accommodate the instrument tipping. The footprint is the area created when an imaginary line is drawn between all of the extremities of the points where the stand is in contact with the ground, and in accordance with the invention, the combined centre of gravity of the instrument and stand is approximately located at the centre of the footprint.

In accordance with the invention, said cradle portion prevents the bottom of the instrument from being dislodged from the stand when the top of the instrument is pushed backwards (it would make the instrument rotate at its base and the stand will flex to accommodate that movement). The front part of the cradle portion prevents the bottom of the instrument coming off the front of the stand. Similarly the cradle portion prevents the instrument being rotated about the axis of its strings off the stand. It also allows the instrument to be dropped casually on the stand by self-location within the cradle. As preferred the cradle portion is formed by left and right portions of said elongate members, which extend from the back portion and are curved in two dimensions in order to locate the bottom of the instrument there between.

The holding means may comprise a clamp arrangement for gripping the neck of the instrument to prevent movement. But in a preferred feature, said holding means comprises one or more said elongate members extending from the back portion to form open arms which restrain lateral movement of the instrument, but do not restrain forward movement; this provides the following advantages:
1) The arms enable the guitar to be carelessly put on the stand
2) The arms enable a cello/violin to be placed backwards to protect the bridge without putting pressure on the strings
3) The arms prevent the instrument being rotated about the axis of the back portion (although the cradle also prevents this), and prevents the top of the instrument being dislodged sideways off the stand.

Said elongate members forming the stand may each be of a rod-like or tubular form, which permit flexing in any direction transverse to its length. This permits an increase in overall flexibility and utility of the stand. As preferred for simplicity, the elongate members may be of all the same material, e.g. steel of a certain diameter, with a plastic cladding. However in some circumstances, the stand may be formed of more than one type of elongate member, e.g. spring steel for those regions where the forces are likely to be greatest (as in the legs and cradle), to ensure that the material will spring back into shape, and mild steel for regions where the forces exerted on the stand are not so great and therefore the likelihood of deforming not so great, or thinner steel rod where flexibility is paramount and thicker steel rod or tube where flexibility is not so important. Further specific areas may include coil spring units for extra flexibility. Non flexible members may be added where flexibility is not needed, for example to form feet.

In a first embodiment, said base is configured as an arcuate or part-circular portion of an elongate member, for resting on a floor surface. This elongate member is configured to extend upwardly to form the back of the stand. The elongate member may extend upwards in spiral fashion from the base to provide extra flexibility. The cradle portion of the stand is formed by one or more elongate members joined to the back portion, and the arms are formed by one or more further separate elongate members. In this embodiment, the major part of the deformation arising from impulse forces on the instrument in the stand occurs in the region of the elongate member which extends upwardly from the base to form said back portion.

In a second and preferred embodiment, the base is formed as a tripod, with at least three legs, one rear leg extending behind the back, and left and right side legs extending to the side and to the front of the stand. Each leg is of a substantial length, and contacts a supporting floor surface at or adjacent its free end. The remainder of the leg is raised from the floor surface and extends upwardly to the the back portion. The front legs have a sinuous configuration along their lengths whereby to define said cradle portion. The lengths of the legs, and their spacing from a floor surface, ensure that impulse forces exerted on the musical instrument are absorbed to a large extent by the legs. A further feature of the invention consists in hinge means located at the base of said back portion, for enabling the base portion and back portion to be folded alongside one another for transportation and storage. In use, the back portion is unfolded to an operative position, and the hinge means is such e.g. lockable or stiff, as to secure the back portion there

### BRIEF DESCRIPTION OF THE DRAWINGS

Preferred embodiments of the invention for each of the cello, guitar and violin will now be described with reference to the accompanying drawings, wherein:

FIG. 1 is a perspective view of the preferred embodiment for a guitar;

FIG. 2 is a perspective view of the stand of FIG. 1 holding a guitar;

FIG. 3 is a side view of the stand of FIG. 1 holding a guitar;

FIG. 4 is a perspective view of the preferred embodiment modified for holding a cello;

FIG. 5 is a perspective view of the stand of FIG. 4 holding a cello;

FIG. 6 is a side view of stand of FIG. 4 holding a cello;

FIG. 7 is a perspective view of a further embodiment for a violin;

FIG. 8 is a side view of the stand of FIG. 7 holding a violin;

FIG. 9 is a perspective view of the stand of FIG. 7 holding a violin;

FIG. 10 is a side view of the stand of FIG. 1 showing the stand bending under downwards pressure, dotted lines indicating movement of stand parts under such pressure;

FIG. 11 is a side view of the stand of FIG. 1 showing the stand bending under backwards pressure;

FIG. 12 is a perspective view of the stand of FIG. 1 showing the stand bending under diagonal pressure on one side;

FIG. 13 is a plan view of the stand showing the stand of FIG. 1 bending under backwards pressure on one side;

FIG. 14 is a front view of the stand of FIG. 1 showing the stand bending under downwards pressure;

FIG. 15 is a front view of the stand showing the stand of FIG. 1 bending under sideways pressure;

FIG. 16 is a side view of a modified version of the stand of FIG. 1 showing a hinge located at the bottom of the back portion for permitting folding of the stand, dotted lines indicating movement of stand while folding; and

FIG. 17 is a side view of the stand of FIG. 1 in a folded position

### DESCRIPTION OF THE PREFERRED EMBODIMENTS

According to the invention, the stand is mainly made from a strong but springy or flexible material which normally returns to its original position and shape after mild pressure or a gentle knock is applied to it. The material can be a single or composite material which has a coefficient of restitution enabling it to flex by bending or twisting and return to its original position and a high yield point so it does not permanently deform or fail when receiving moderate knocks or pressure. An example is thin rod or tube made of metal, composite material, plastic or wood. The material and the configuration of the stand are such that when mild pressure is applied, the stand will normally bend or twist before the instrument it is holding will be crushed or damaged. Also the material allows the stand to flex in multiple directions. This can be achieved by the shape and dimensions of the material as well as from the characteristics of the material itself.

It is possible to achieve a springy stand where the springy material is combined with more rigid material. An example would be solid feet attached to the end of the springy material. The amount of the rigid material which can be attached to the spring can vary. For example, lengths of more rigid or inflexible material could be attached to coiled springs or other flexible or springy material, enabling the length of inflexible material to be deflected in any direction. According to the invention, the configuration of the stand is designed to allow it to bend or twist when the instrument or the stand is gently knocked, subsequently returning to its original position. In this way the stand will absorb the force rather than the instrument, while still holding the instrument safely. Examples of this springiness in the design of the guitar stand are described below.

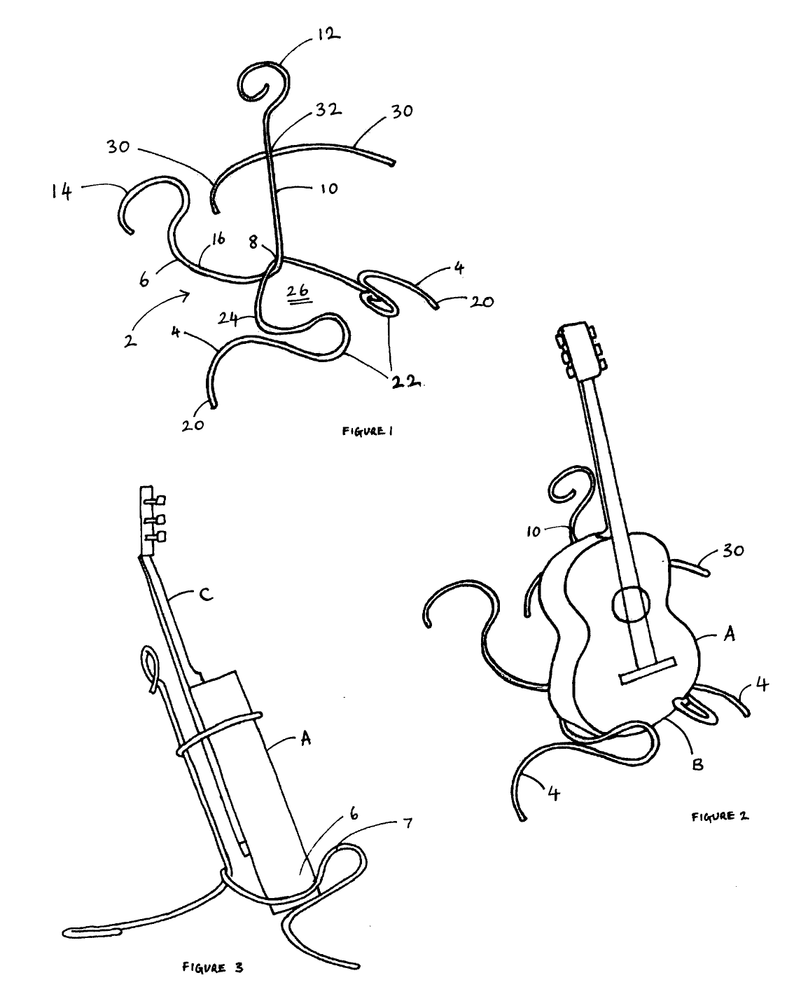

According to the invention, the stand has a wide base so that the centre of gravity of the stand together with the instrument usually stays within the footprint of the stand even when the instrument or the stand is gently knocked into. For example, when the stand or the instrument is gently knocked into, rather than toppling over, the stand flexes and a foot of the stand may lift off the ground briefly before the stand eventually returns back to its original position. However, unless the knock is sufficient to take the centre of gravity of the instrument and the stand outside the footprint of the stand, the stand will settle back down, eventually returning to its original position. This may be achieved in different ways, for example by having a number of legs whose ends terminate far enough away from each other to provide a wide base, or by having one or more legs which make contact with the floor at points along their length which are spaced and at a distance from the centre of gravity to provide a wide base. Examples of these different approaches are shown in FIGS. 1, 4 and 7.

Preferably the part of the stand in contact with the instrument may be covered in a material which creates friction between the instrument and the stand, reducing the risk of the instrument slipping off; and which also provides cushioning between the instrument and the stand. An example of this is silicone rubber or other plastic.

The stand may have a covering or attachment which extends out beyond the framework of the stand which is made of an extremely flexible material. This material might be brightly coloured to make it more visible. The purpose of this may be two fold. Firstly the stand is more visible thus encouraging passers by to give the instrument and stand a wider berth making it less likely they will be knocked into. Secondly as the extended material is completely flexible it will not damage the instrument or cause the stand to move significantly if knocked into. An example of such material is soft fabric or soft rubber tubing.

According to the invention, the stand may be configured to enable a stringed instrument such as a cello to be held with the back of the instrument turned to face outwards, thereby reducing the risk of the strings and bridge of the instrument from being knocked into and damaged. An example of how this may be achieved is the stand may have arms which are configured to support the body of the instrument by supporting the outer edges of the instrument while avoiding contact with the central strings and bridge.

According to the invention, the configuration of the stand is such that the instrument is supported at several different points so that it is unlikely to rotate off the stand when accidentally knocked into. Instead, the stand will flex while still holding the instrument, and eventually return back to its original position. An example of this is a stand which cradles the base of the instrument with a shaped base leg. Also the stand may have arms which not only support the back of the instrument but also the sides, preventing the instrument from falling off the stand if gentle knocks are applied from a forward or sideways direction. They will also prevent the instrument from rotating off the stand if a gentle force is applied to one side. The stand may be configured to extend the top central section in front of the instrument to prevent any gentle knocks from behind from pushing the instrument off the stand forward. This may be achieved, for example, by extending an upper looped handle at an angle forwards to extend in front of the neck of the instrument. It may also be achieved by extending the arms in front of the instrument or enabling the soft material referred to above to be used to restrain the instrument.

The stand may be configured to provide a convenient carrying handle. This may be achieved, for example, by the back portion being extended into a loop. The carrying handle may be configured to enable the bow of the instrument to be hung from or supported by it. This may be achieved for example, by extending the loop slightly in an upwards direction to enable the bow to be hung from it such as shown in the drawings. The base of the stand may be configured to locate the lower part of the bow. This may be achieved, for example, by extending one of the feet of the stand into a horizontal loop.

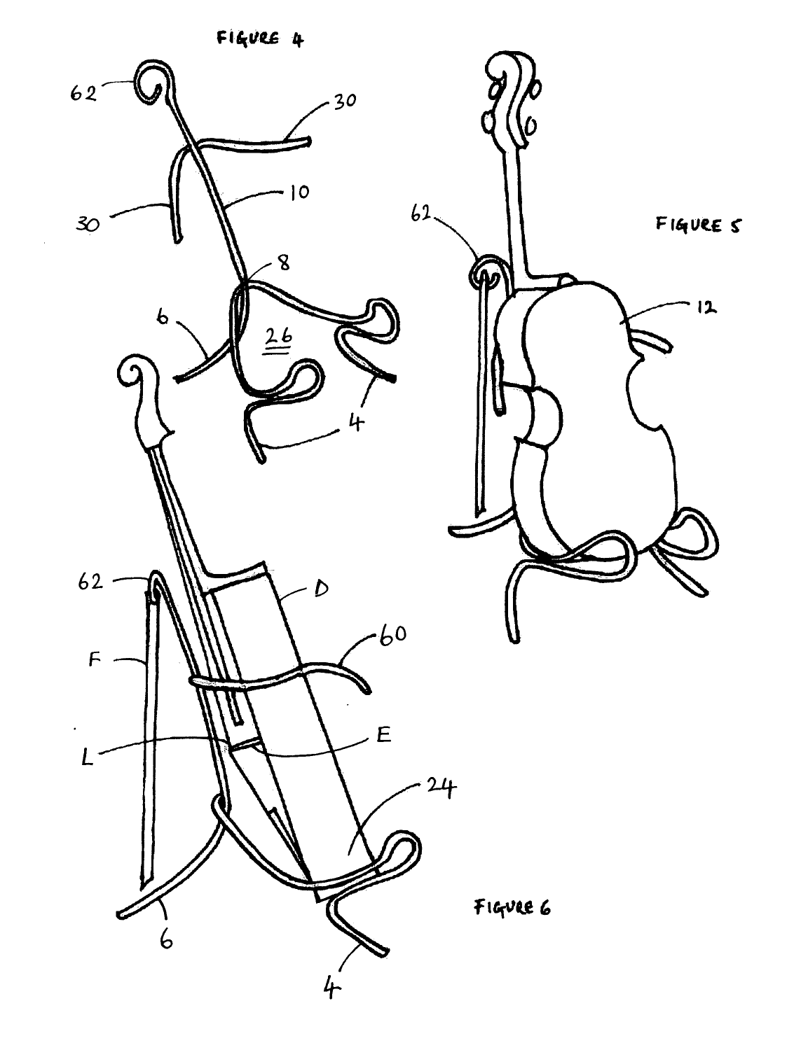

One embodiment of the invention adapted for a guitar or other similar instrument is shown in FIG. 1 and is shown with a guitar in FIGS. 2 and 3. The stand has a base portion 2 comprising left and right front legs 4, which are formed from a single elongate rod of spring steel, with a plastic cladding. The base portion also has a rear leg 6, also formed from a single elongate rod of spring steel, with a plastic cladding. This rod extends upwardly from a join 8 with the front legs, to form a generally vertically extending back portion 10, which terminates in a loop 12 forming a handle.

The three legs of the base portion form a tripod, and make angles of approximately 120° to each other. Rear leg 6 has a loop portion 14 at its free end resting on the floor surface, and the remainder of the leg 16 rises, gently curving, above the floor to the apex of the tripod at join 8. Left and right front legs each have an outwardly extending free end, forming a foot portion 20. The leg then bends upwardly sharply from the floor surface, and is then folded over to define a loop portion 22. The leg curves downwardly from loop 22, and then up to join 8, to form a concave recess portion 24. Loop 22 together with recess portion 24 define an open cradle portion 26, for holding the base or bottom of a guitar as shown in FIGS. 2 and 3. The guitar comprise a body portion A having a bottom part B, and a neck portion C. The cradle portion 26 makes it difficult for the base of the guitar to slip off forwards or laterally. The legs 4, 6 extend a very substantial distance beyond the cradle portion, and the centre of gravity of the stand and guitar is approximately aligned with the rear of the cradle portion, and join 8, and is roughly at the centre of the footprint of the stand.

This embodiment has two open arms 30, which are formed from a single elongate rod of steel, with a plastic cladding, which is joined at 32 to the upper part of the stand. Arms 30 are slightly curved forwardly, to support the upper part of the body of the guitar. However the arms do not embrace or grip the guitar to prevent it from being moved in a forward direction. The arms are curved slightly to make it less likely the instrument will slip or rotate off the stand when accidentally knocked into, as the arms will flex and rotate while holding the guitar.

In use, the guitar may be dropped casually into the stand. The cradle portion 26, being of open recessed form will enable the bottom of the guitar to self locate therewithin, and the upper part of the body will also self locate within arms 30, and be restrained from lateral movement by arms 30. The guitar will rest, inclined to the vertical, parallel to back portion 10. Shock loadings caused by “dropping” the guitar in the stand, will be absorbed by movement of cradle portion 26, back 10 and arms 30, principally as a result of the great flexibility of the tripod base, which is caused by the sinuous and lengthy configuration of legs 4, 6.

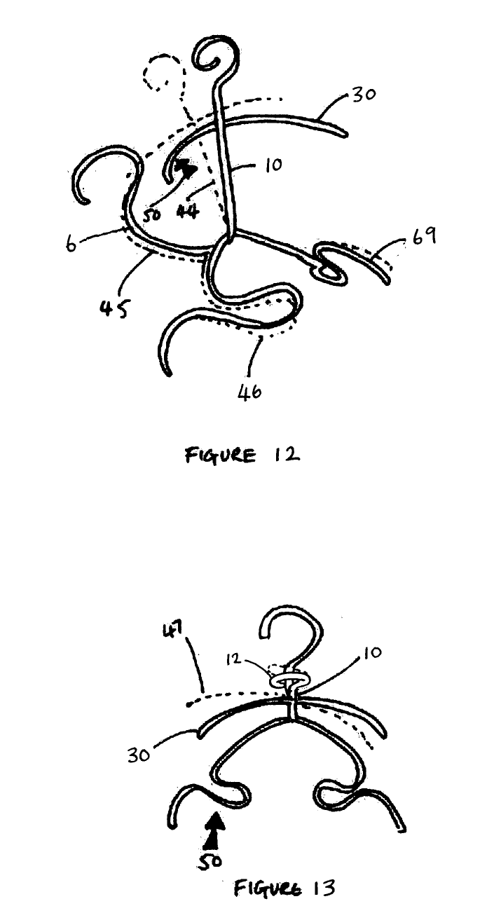

If an uneven downward pressure is applied to the guitar, for example when being placed on the stand, the legs are able individually to flex or rotate to absorb this pressure. If a sideways pressure is applied to the guitar the back 10 is able to flex in any direction and would only result in the stand and instrument falling over if the pressure were sufficient to take the centre of gravity of the instrument and stand outside the wide base. The results of such pressures, forces and shock loadings are shown more specifically in FIGS. 10 to 15. For example in FIGS. 10 and 14, if a force 48 is applied to the guitar forcing it downwards (including gravity when the guitar is placed or dropped on the stand), the front legs 4 and the back leg 6 will bend downwards to the dotted configuration 40, and the arms 30 and back 10 will follow downwards as at 39.

FIG. 11 shows how the stand will bend and spring if a force 49 is applied directly backwards on the guitar. The back 10 will bend backwards as at 41 while the back leg 6 will bend downwards as at 43 and the front legs and cradle 26 will spring upwards as at 42.

FIGS. 12 and 13 shows the flexibility where a force 50, is applied to the top right corner of the body A of the guitar shown in FIG. 2. Force 50 represents a torque about join region 8, and the back portion 10 will twist back at 44 taking the arms 30 with it as at 47. The front left leg 4 is bent downwardly as at 46, and the back leg 8 bends downwardly as at 45. The front right leg, as at 69, may spring up or lift slightly off the floor before settling back down. The whole stand may then sway gently until the stand settles in its original position.

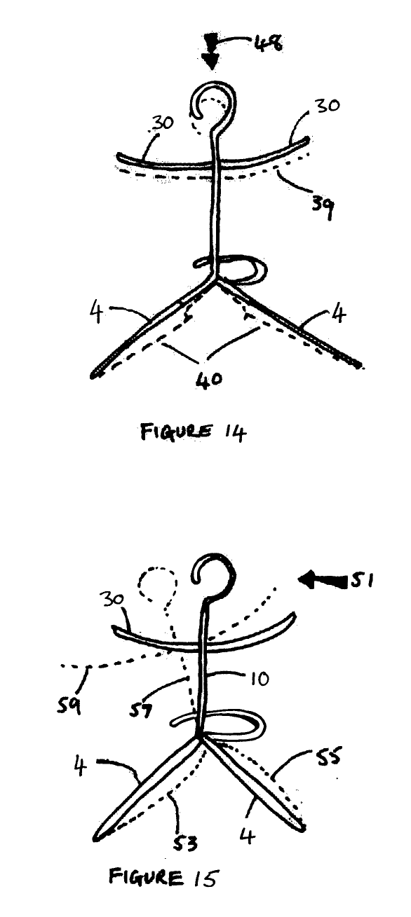

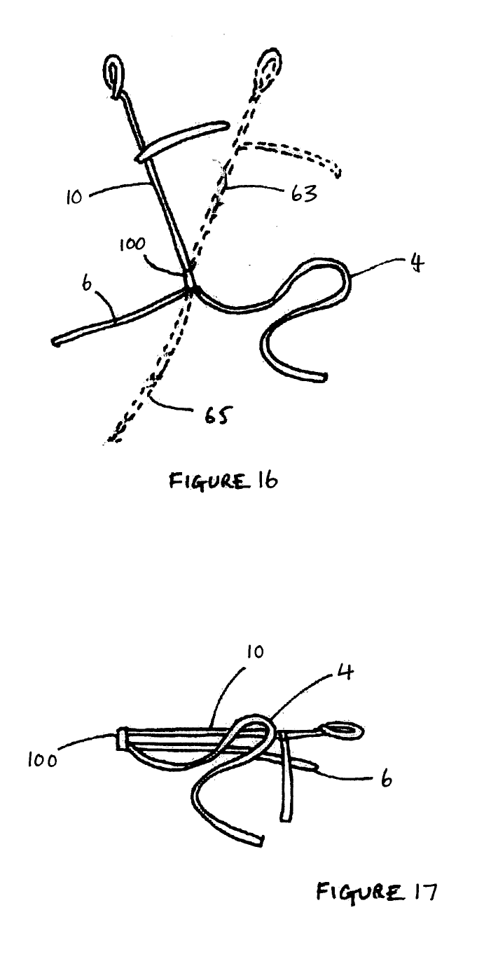

FIG. 15 shows a sideways force 51 applied to the top of the guitar causing left front leg to bend downwards as at 53, the right front leg to spring upwards as at 55, the back 10 to bend sideways as at 57 taking the arms 30 with it as at 59.

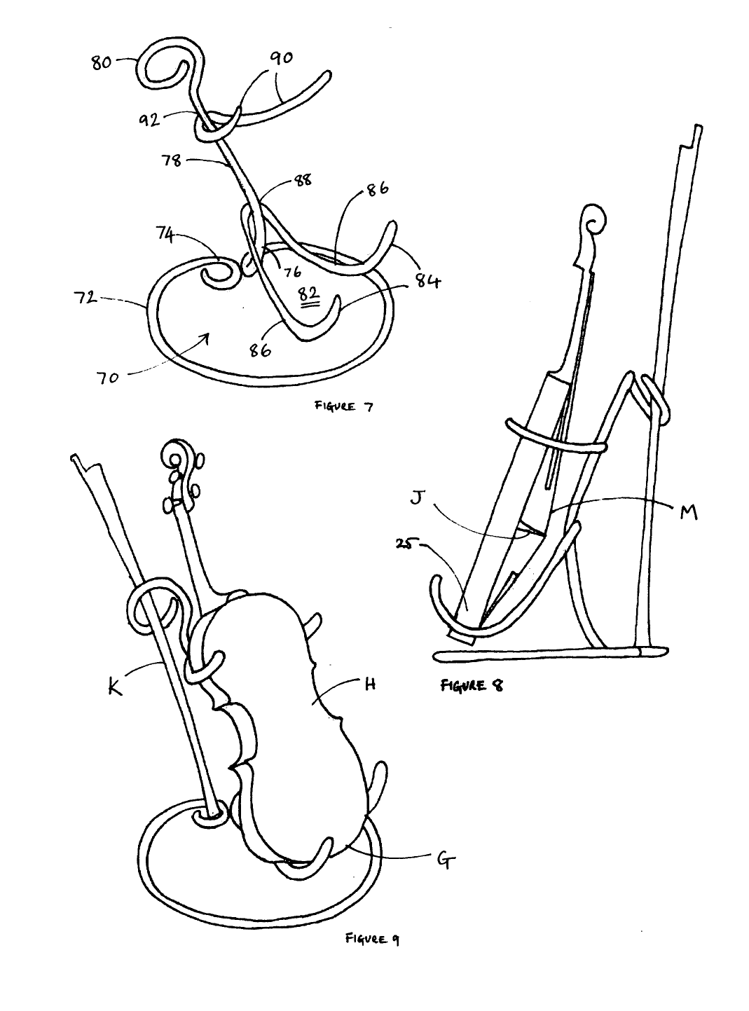

A modification of the embodiment of FIG. 1 is shown in FIGS. 4 to 6, adapted for a cello or other instrument of similar construction. Similar parts to those of FIG. 1 are denoted by similar reference numerals. Differences reside principally in the dimensioning of the parts of the stand to accommodate the different shape of the cello as compared to a guitar. The cradle portion 26 is formed with a longer recess 24, which is further from join 8. Arms 30 terminate with protruding flexible material extensions 60, designed to make the stand more noticeable and to encourage passers by to give the stand a wider berth. Arms 30 roughly at right angles to each other support the upper part of the body of the cello body D and prevent the strings L and bridge E of the cello resting on the stand. The combined centre of gravity of the cello and the stand is roughly above the middle of the triangle created by the ends of the front and back legs 4,6 contacting the ground (i.e. in the centre of the footprint). Back portion 10 terminates at the top with a loop 62 which acts as a carrying handle. The loop 62 is disposed to enable the bow F to be suspended from it.

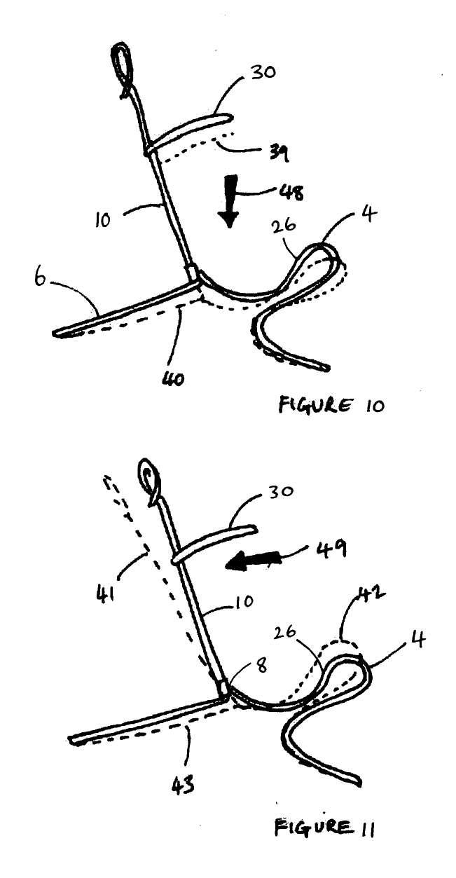

A further embodiment of the invention adapted for a violin or other similar instrument is shown in FIGS. 7, 8 and 9. This embodiment has a base 70 formed by a circular arc portion 72, which rests on a floor surface, and which terminates in a loop 74 at the rear of the stand. The base portion is formed by a single elongate rod of spring steel, with a plastic cladding, and this rod extends steeply upwardly and forwardly in a curved portion 76 to define a vertically and backwardly extending back portion 78. Back portion 78 terminates in a loop 80, which is angled downwardly, as best seen in FIG. 8. A cradle portion of the stand 82 is formed by a plastic clad steel rod, which defines left and right legs 84, each being concavely curved to form an open recess region 86, to hold the bottom G of the body H of the violin. The rod is joined to the back portion 78 as at 88 in the transition region with the curved portion 76. Arms 90 are formed by a plastic clad steel rod, which defines left and right arms and which is joined to an upper part of back portion 78 as at 92. Arms 90 are of an open configuration to receive and support the upper part of the violin body H, and prevent the strings M and bridge J of the violin resting on the stand.

When the violin is placed on the stand, the open configuration of both the cradle portion 82 and the arms 90 will enable the violin to self locate within the stand. It will then rest inclined backwardly to the vertical, generally parallel to back portion 78, and with the combined centre of gravity of the violin and the stand roughly above the centre of the wide base 70. Base 70 provides a stable base support for the body of stand. The end of the arc 72 terminates in a loop 74 in which the end of the bow K can be placed and which prevents the bow from slipping on the surface. The back portion 78 is supported, via upward portion 76, by the base, and is able to flex in any direction when pressure is applied. The loop 80 acts as a carrying handle and into which the bow can be inserted in order to support the upper part of the bow K.

The back portion 78, together with cradle portion 82 and arms 90, which it supports, have the ability to flex in any direction when mild pressure is applied. In this example the back portion 78 and 76 can bend or twist backwards and forwards or up and down. If the stand in FIG. 7 is knocked into, the back portion 78 will flex, and one side of the curved arc 72 may lift slightly off the ground before settling back down.

A modification of the stand of FIG. 1, adapted for the guitar or other similar instrument is shown in FIGS. 16 and 17, wherein similar parts to those of FIG. 1 are denoted by the same reference numeral. It additionally has a hinge 100 which is positioned at the join 8 between legs 4, 6 and back portion 10. The back portion 10 and the back leg 6 are hinged so that they are able to rest open as shown in FIG. 16, or rotate towards the front legs 4 as shown in dotted lines at 63 and 65. When fully folded the front legs 4, back leg 6 and back portion 10 are aligned along side one another as shown in FIG. 17. The hinge has a locking facility to enable the stand to be locked in the open position of FIG. 16. The hinge 100 enables the back portion 10 to rotate forwards as at 63 and the back leg 6 to rotate under the front legs as at 65. FIG. 17 shows the stand in a folded position with the central upright 10, forward legs 4 and back leg 6 in the same general direction. This has several advantages. It enables the stand to be transported easily and it enables the stands to be stacked together for transport and storage. An additional advantage is that provided the hinge is not too tight or locked into a folded position, it enables the user to fold and unfold the stand with one hand while holding the guitar with the other hand.

Features of the invention are as follows:
1 A stand for a stringed instrument, having a frame work made of a flexible or springy material
2 A stand for a stringed instrument, having a frame work made of both a flexible or springy material and more rigid material, such that the springy material enables the more rigid material to be moved in different directions
3 An instrument stand wherein the configuration of the stand is designed to allow it to spring, yield, bend or twist when mild pressure or a gentle knock or shock or vibration is applied to the instrument or the stand
4 An instrument stand wherein the stand has a wide base.
5 An instrument stand wherein the stand has a wide base, the elements of which are able to spring, yield, bend or twist to different degrees.
6 An instrument stand wherein the configuration of the stand is such that the instrument is supported at the base
7 An instrument stand wherein the configuration of the stand is such that the instrument is supported at the sides.
8 An instrument stand wherein arms which support the body of the instrument are able to spring, yield, bend or twist to different degrees
9 An instrument stand wherein arms support the body of the instrument which are shaped to prevent the instrument slipping off the stand following mild pressure from different directions on the instrument
10 An instrument stand wherein supports for the base of the instrument are able to spring, yield, bend or twist to different degrees
11 An instrument stand wherein the arms are configured to enable a stringed instrument to be placed with the back of the instrument turned to face outwards without the stand touching the strings and bridge of the instrument
12 An instrument stand wherein the stand has a central component which is able to spring, yield, bend or twist
13 An instrument stand wherein the central component may be configured to provide a convenient carrying handle.
14 An instrument stand wherein the central component carrying handle may be configured to enable the bow of a stringed instrument to be hung.
15 An instrument stand wherein the central component may be configured to enable the bow to be held upright when the base of the bow is resting elsewhere
16 An instrument stand wherein the base of the stand is configured to provide a locating point for one end of the bow.
17 An instrument stand wherein the central component and the legs comprising the base are attached together at a hinging point so that when folded the central component and the legs all lie in the same direction.
18 An instrument stand wherein the part of the stand in contact with the instrument is covered in a material which creates friction between the instrument and the stand
19 An instrument stand wherein the part of the stand in contact with the instrument is covered in a material which provides cushioning between the instrument and the stand.
20 An instrument stand wherein the flexible covering or an attachment extends out beyond the framework.
21 An instrument stand wherein the stand is configured so that the instrument is physically held on the stand, preventing it from being accidentally knocked off the stand.
22 The springy components of the instrument stand are made of a single or composite material which has a coefficient of restitution and a high yield point.

1. A stand for a stringed musical instrument having a body portion and a neck portion along which the strings extend, the stand comprising a plurality of elongate members of the type defined herein, said elongate members being configured to provide a base for resting on a floor surface, a back portion extending upwardly from the base, a cradle portion for supporting the weight of the instrument in a vertical direction, and for restraining movement of the instrument in horizontal directions, and the stand including holding means secured to the back portion above the cradle portion to hold the stringed instrument against lateral movement, and the base extending a substantial distance at least to the rear of the cradle portion for stability, the arrangement being such that the cradle portion and back portion are resiliently movable in use to absorb forces that may be exerted on the instrument.

2. A stand according to claim 1, wherein said elongate members are each in a rod-like or tubular form, which permits flexing in any direction transverse to its length.

3. A stand according to claim 1, wherein said holding means comprises one or more said elongate members extending from the back portion to form open arms which restrain lateral movement of the instrument, but do not restrain forward movement.

4. A stand according to claim 1, wherein said base is configured as an arcuate or part-circular portion of a first said elongate member, for resting on a floor surface, said first elongate member being configured to extend upwardly to form said back portion of the stand.

5. A stand according to claim 1, wherein the cradle portion of the stand is formed by one or more second said elongate members joined to the back portion.

6. A stand according to claim 5, wherein the cradle portion has left and right leg portions, each leg portion being curved concavely from its free end towards the back portion, to define an open recess for location the base of the body of the instrument.

7. A stand according to claim 1, wherein the base is formed with at least three legs, one rear leg extending behind the back, and left and right side legs extending to the side and to the front of the stand, wherein each leg is of a substantial length, and contacts a supporting floor surface at or adjacent its free end, the major part of each leg being raised from the floor surface and extending upwardly to the the back portion.

8. A stand according to claim 7, wherein each front leg has a sinuous configuration along its length whereby to define said cradle portion.

9. A stand according to claim 8, wherein each front leg is bent upwardly from a free end to define a loop portion, the loop portion defining the front end of the cradle portion, and the front leg being curved concavely, between the loop portion and the back portion to define an open recess of the cradle portion.

10. A stand according to claim 7, wherein the free end of the rear leg has a loop portion for stability.

11. A stand according to claim 1 wherein the back portion extends vertically but is inclined towards the rear of the stand, such that the centre of gravity of the instrument in the stand is close to the rear of the cradle portion.

12. A stand according to claim 1, wherein the top region of said back portion is formed to define a loop.

13. A stand according to claim 12, wherein the loop is disposed to form a location for a bow of the instrument.

14. A stand according to claim 3, wherein the open arms have extension members for guard purposes.

15. A stand according to claim 1, including hinge means located at a join between said back portion, to enable the stand to be moved from an operative position, to a folded position.

16. A stand according to claim 1, wherein said base extends a substantial distance to the sides of the cradle portion for stability.

17. A stand according to claim 4 wherein the open end of the arcuate or part-circular portion ends in a curve for locating the base of a bow.
